(19) United States
(12) Patent Application Publication
(10) Pub. No.: US 2007/0024732 A1
(43) Pub. Date: Feb. 1, 2007

(54) Driving device and driving method for solid state imaging element

(76) Inventors: Akihiro Kuroda, Anpachi-gun (JP); Shinichiro Izawa, Motosu-shi (JP)

Correspondence Address: CANTOR COLBURN, LLP, 55 GRIFFIN ROAD SOUTH, BLOOMFIELD, CT, 06002, US

(21) Appl. No.: 11/495,238

(22) Filed: Jul. 28, 2006

(30) Foreign Application Priority Data
Jul. 28, 2005 (JP) 2005-219309

(51) Int. Cl. H04N 5/335

(52) U.S. Cl. 348/311

(57) ABSTRACT

In a solid state imaging element in which a plurality of bits are provided for storing information charges, during transfer of an information charge, a transfer electrode corresponding to a bit storing the information charge to be transferred is set to an OFF state and at least one transfer electrode corresponding to at least one of bits at a later stage along a transfer direction which is adjacent to the bit is set to a potential lower than that in the ON state.

### CROSS-REFERENCE TO RELATED APPLICATIONS

The entire disclosure of Japanese Patent Application No. 2005-219309 including specification, claims, drawings and abstract is incorporated herein by reference.

### BACKGROUND OF THE INVENTION

1. Field of the Invention

The present invention relates to a driving device and a driving method for a solid state imaging element in which a transfer rate and reproducibility of a captured image signal are improved.

2. Description of the Related Art

Recently, imaging devices such as digital still cameras and video cameras, in which a solid state imaging element such as a CCD solid state imaging element is incorporated, are in wide use. The solid state imaging elements include, for example, a frame-transfer type CCD solid state imaging element.

FIG. 6 is a structural diagram of a frame transfer type CCD solid state imaging element 2. As shown in FIG. 6, the CCD solid state imaging element 2 comprises an imaging section 2i, a storage section 2s, a horizontal transfer section 2h, and an outputting section 2d. The imaging section 2i comprises a plurality of vertical shift registers placed in parallel to each other in the vertical direction. Each bit of each vertical shift register forms a light receiving pixel and generates an information charge corresponding to intensity of light incident from the outside. The information charge is stored in a potential well by applying a voltage on a transfer electrode provided in the imaging section 2i. During transfer, a vertical clock pulse applied to the transfer electrode is received and the information charge stored in each pixel is transferred to the storage section 2s. The storage section 2s comprises a plurality of vertical shift registers placed in parallel to each other and continuous from the vertical shift registers of the imaging section 2i. The storage section 2s receives a vertical clock pulse which is applied to the transfer electrode and stores and transfers the information charge transferred from the imaging section 2i in the vertical direction. The horizontal transfer section 2h is placed at the output side of each vertical shift register of the storage section 2s and comprises a horizontal shift register having each bit coupled to the output of each vertical shift register of the storage section 2s. The horizontal transfer section 2h receives a horizontal clock pulse and sequentially transfers the information charge transferred from the storage section 2s to the outputting section 2d. The outputting section 2d is placed at the output side of the horizontal transfer section 2h and comprises a capacitor for storing the information charge and converting the information charge to a voltage. The outputting section 2d stores, in the capacitor, the information charge transferred from the horizontal transfer section 2h, converts the information charge to a voltage corresponding to the amount of charge, and outputs as an output signal. The voltage value of this output signal is the image signal.

In a CCD solid state imaging device targeted for capturing a color image, color filters of red (R), green (G), and blue (B) are placed in a mosaic pattern corresponding to the light receiving pixels of the imaging section 2i, as shown in FIG. 7. Light is incident on each light receiving pixel through one of the color filters of red (R), green (G), and blue (B), and information charge corresponding to the intensity of light in the transmitting wavelength band is generated in each light receiving pixel.

In order to enable high-speed transfer in such a solid state imaging device for color imaging, Japanese Patent Laid-Open Publication No. Hei 10-224809 (Reference 1) discloses a solid state imaging device in which each bit of a horizontal shift register of the horizontal transfer section is placed corresponding to each combination of an odd line and an even line of the vertical shift register of the storage, and control is applied so that the information charge is alternately transferred from the odd and even lines of the vertical shift register at each horizontal transfer period to achieve a horizontal transfer period which is ½ of the conventional devices.

FIGS. 8A-8D and 9 show movement of information charge and a change of potential well at a connection portion between the storage section 2s and the horizontal transfer section 2h during horizontal transfer in the solid state imaging device of the related art. FIG. 8 shows movement of the information charge along a planar direction at the connection portion between the storage section 2s and the horizontal transfer section 2h. FIG. 9 shows a placement of the transfer electrode of the horizontal transfer section 2h at the uppermost portion. (a)-(d) in FIG. 9 show a change of potential well and movement of the information charge (information charges for different colors are shown with different hatchings) along the horizontal transfer direction in correspondence to the placement of the transfer electrode of the horizontal transfer section 2h. In (a)-(d) of FIG. 9, the horizontal axis represents a position corresponding to the horizontal transfer electrode and the vertical axis represents the potential, the upward direction being a negative potential and the downward direction being a positive potential. In FIGS. 8A-8D and 9, a portion of the connection portion between the storage section 2s and the horizontal transfer section 2h near the outputting section 2d is shown in order to simplify the explanation.

Here, a case is described in which information charges corresponding to red (R) and green (G) are transferred to the final stages of the vertical shift registers of the odd and even lines of the storage section 2s, respectively. As shown in FIG. 8A and (a) in FIG. 9, first, the information charge of red (R) is transferred from the odd line of the vertical shift register of the storage section 2s to the horizontal transfer section 2h. Then, as shown in FIG. 8B and (b) of FIG. 9, the horizontal clock pulse to be applied to the transfer electrode of the horizontal transfer section 2h is controlled so that the information charge is sequentially transferred along the horizontal transfer direction to add information charges of a plurality of pixels corresponding to red (R). Here, the information charges of red (R) in the (6n+3)th line and (6n+5)th line (where n is 0 or a natural number) are added to the information charge of red (R) in the (6n+1)th line. Then, as shown in FIG. 8C and (c) of FIG. 9, while the information charge which is added and combined is stored in the bit of the horizontal shift register connected to the odd line of the vertical shift register, the information charges are transferred from the even line of the vertical shift register of the storage section 2s to the horizontal transfer section 2h. Then, as shown in FIG. 8D and (d) in FIG. 9, the horizontal clock pulse to be applied to the transfer electrode of the horizontal transfer section 2h is controlled so that the information charge is sequentially transferred along the horizontal transfer direction to add the information charges of a plurality of pixels corresponding to green (G). Here, the information charges of green (G) for the (6n+4)th line and (6n+6)th line (where n is 0 or a natural number) are added to the information charge of green (G) of the (6n+2)th line. In this manner, information charges added for each color are horizontally transferred to the outputting section 2d.

In this manner, by mixing the information charges for a plurality of pixels, the intensity of the image signal is strengthened, and thus an image signal having a sufficient level can be obtained even without insufficient exposure such as when a target is captured in the dark. In addition, it is possible to realize a high-speed horizontal transfer by reducing the number of pixels to be horizontally transferred.

When, however, information charges of green (G) newly transferred from the vertical shift register of the storage section 2s are to be horizontally transferred, added, and combined while the added and combined information charges of red (R) are stored in the horizontal shift register as shown in (a) of FIG. 10, the depth of the potential well 52 storing the information charges of the red (R) which have already been added and combined is reduced following the change of the potential well 50 storing the information charges of green (G) which are to be transferred, due to the influence of the coupling capacitance between transfer electrodes as shown in (b) of FIG. 10. Because of this, the information charges of red (R) stored in the potential well 52 leak to the adjacent potential well 54, which causes the information charge of red (R) and the information charge of green (G) stored in the potential well to be added. Such an unnecessary mixture of information charges may cause reduction of the image quality (reproducibility) of the image captured by the solid state imaging element.

### SUMMARY OF THE INVENTION

According to one aspect of the present invention, there is provided a driving device and a driving method for a solid state imaging element in which a plurality of bits are provided for storing information charges, and an information charge stored in a bit of a later stage along the transfer direction among two adjacent bits is transferred to a bit of an earlier stage along the transfer direction by setting a transfer electrode corresponding to the bit at the earlier stage along the transfer direction to an ON state and setting a transfer electrode corresponding to the bit of the later stage along the transfer direction to an OFF state having a lower potential for electron than the ON state, wherein, during transfer of the information charge, a transfer electrode corresponding to a bit storing the information charge to be transferred is set to the OFF state and at least one transfer electrode corresponding to at least one bit of the later stage along the transfer direction adjacent to the bit is set to a potential lower than that of the ON state.

### BRIEF DESCRIPTION OF THE DRAWINGS

A preferred embodiment of the present invention will be described in detail based on the following drawings, wherein:

FIG. 1 is a diagram showing a structure of a solid state imaging device according to a preferred embodiment of the present invention;

FIG. 2 is an enlarged view of a primary structure of a solid state imaging element according to a preferred embodiment of the present invention;

FIG. 3 is a timing chart of a clock pulse which controls a solid state imaging element according to a preferred embodiment of the present invention;

FIG. 4 is a timing chart of a clock pulse which controls a solid state imaging element according to a preferred embodiment of the present invention;

FIG. 5 is a diagram showing a change of potential of a horizontal transfer section in a preferred embodiment of the present invention;

FIG. 6 is a diagram showing a structure of a solid state imaging element in a related art;

FIG. 7 is a diagram showing an arrangement of color filters in a solid state imaging element of a related art;

FIGS. 8A-8D are explanatory diagrams showing movement of information charges when the information charges are added and combined in a horizontal shift register in a solid state imaging element in a related art;

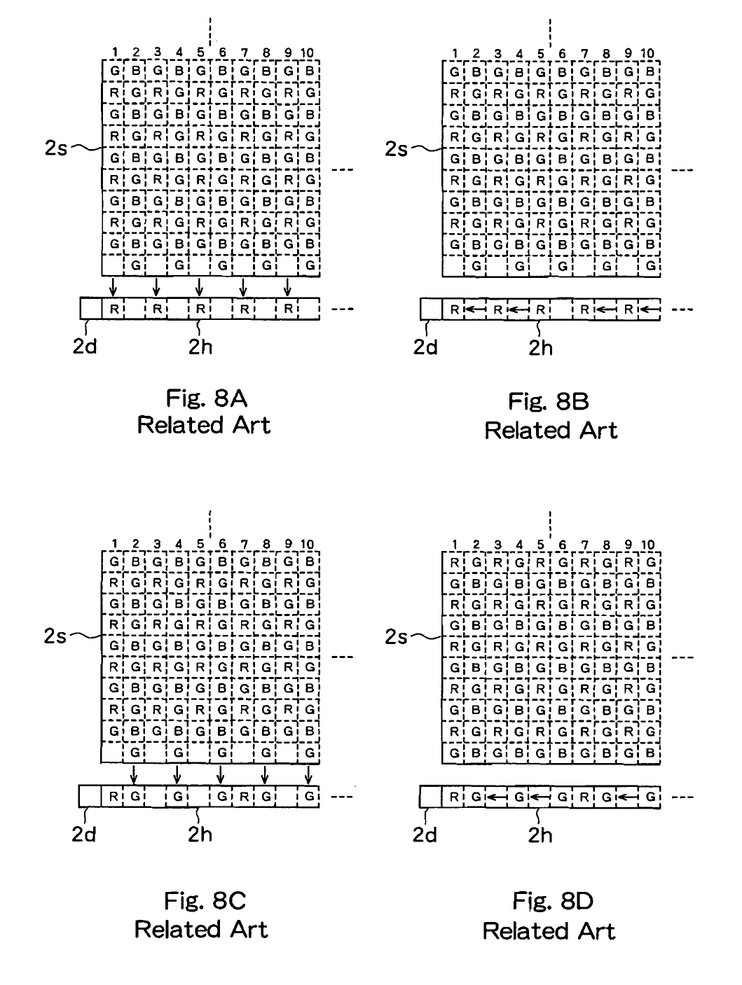

FIG. 9 is an explanatory diagram showing a potential and a movement of information charges during addition and combination of the information charges in a horizontal shift register in a solid state imaging element according to a related art; and

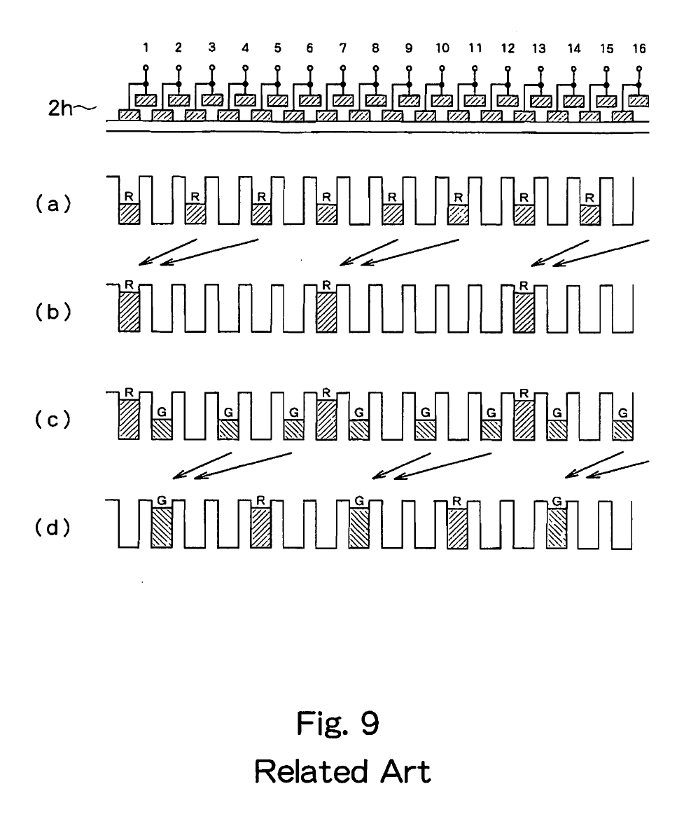

FIG. 10 is a diagram for explaining a problem during addition and combination of information charges in a solid state imaging element according to a related art.

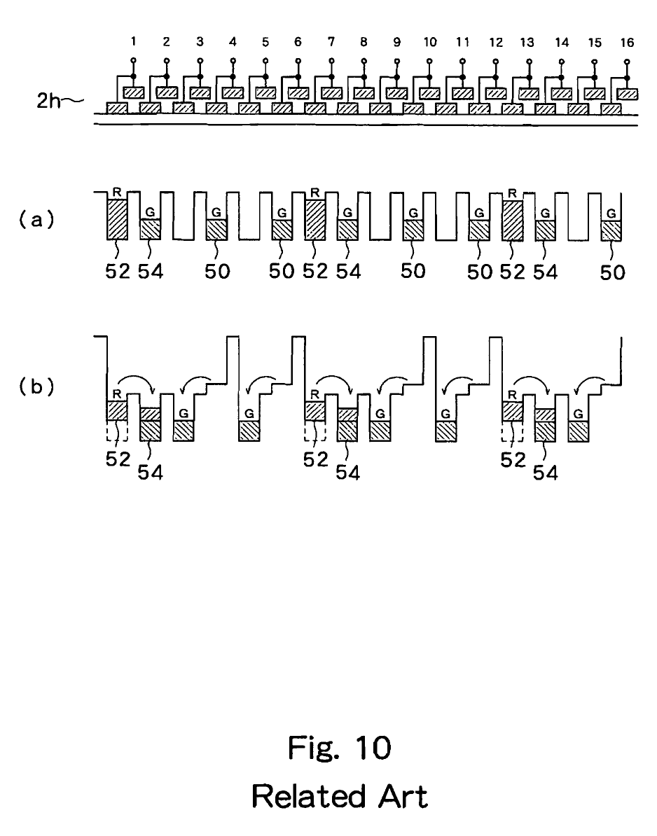

### DESCRIPTION OF PREFERRED EMBODIMENT

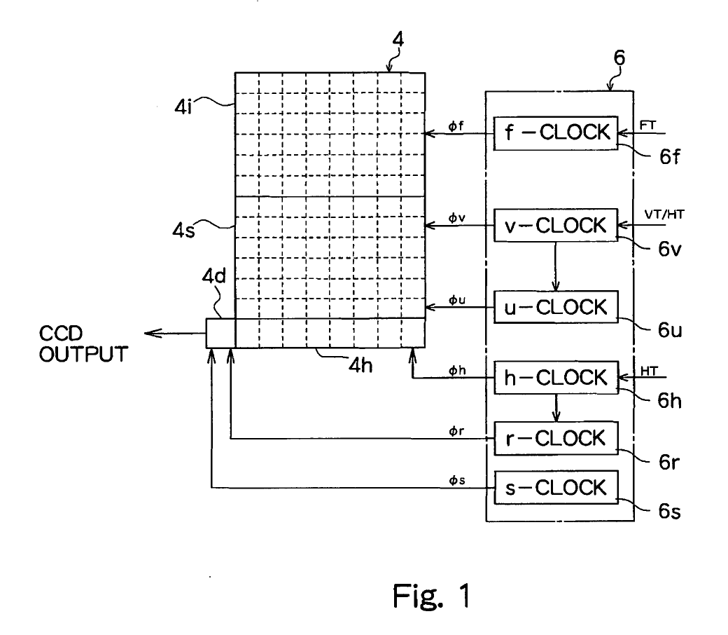

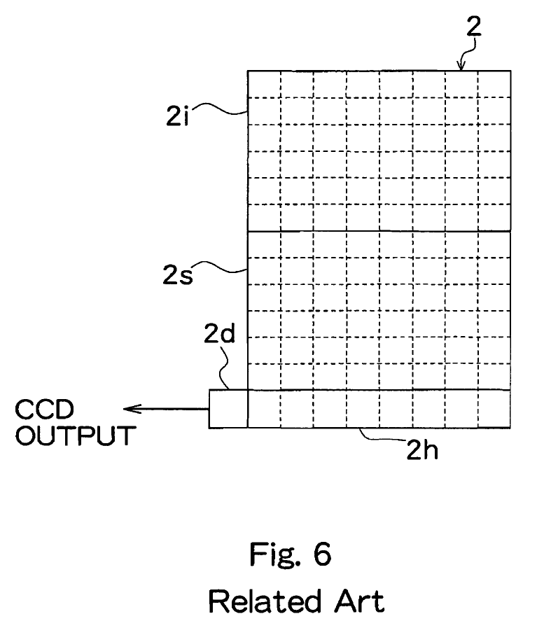

As shown in FIG. 1, a solid state imaging device according to a preferred embodiment of the present invention comprises a CCD solid state imaging element 4 and a driving device 6. The CCD solid state imaging element 4 which is of a frame transfer type comprises an imaging section 4i, a storage section 4s, a horizontal transfer section 4h, and an outputting section 4d, similar to FIG. 6. The driving device 6 comprises a frame clock pulse generating section 6f, a vertical clock pulse generating section 6v, an auxiliary clock pulse generating section 6u, a horizontal clock pulse generating section 6h, a reset clock pulse generating section 6r, and a sampling clock pulse generating section 6s. The driving device 6 controls the CCD solid state imaging element 4 by supplying various clock pulses.

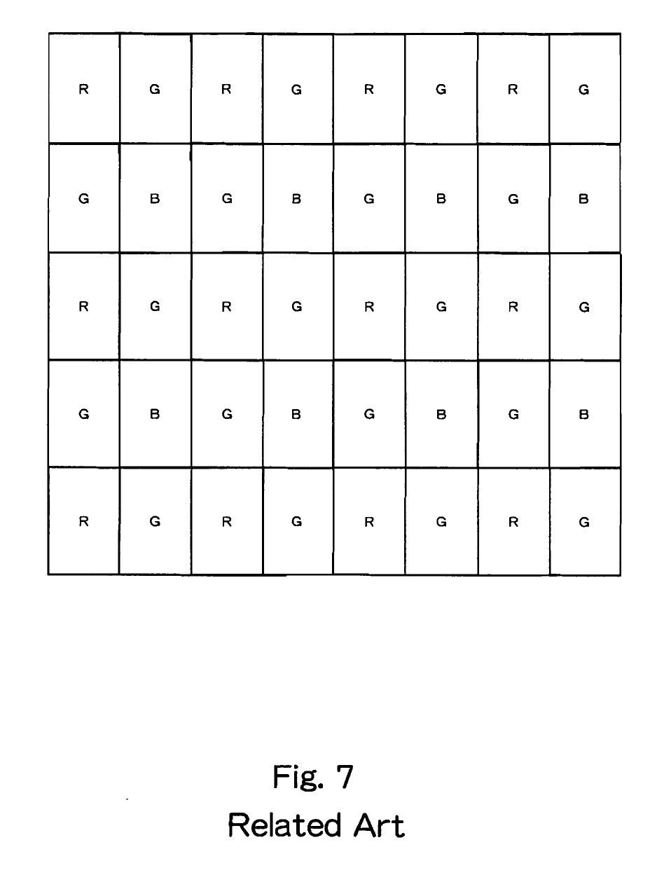

The imaging section 4i comprises a plurality of vertical shift registers placed along the vertical direction in parallel to each other. Each bit of each vertical shift register forms a light receiving pixel and stores, during the imaging process, an information charge generated corresponding to the intensity of light incident from the outside. In the imaging section 4i of the preferred embodiment, color filters of red (R), green (G), and blue (B) are placed in a mosaic pattern corresponding to the light receiving elements as shown in FIG. 7.

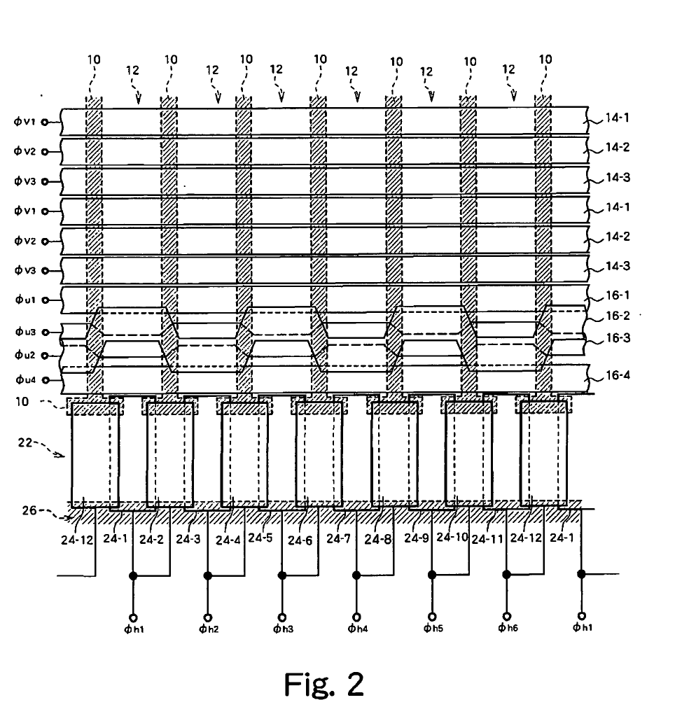

FIG. 2 is a plan view showing a structure of a connection portion between the storage section 4s and the horizontal transfer section 4h of the CCD solid state imaging element 4 according to the preferred embodiment.

The storage section 4s comprises a plurality of vertical shift registers extending in parallel to each other. The vertical shift register is formed in the following manner. A P well (PW) which is a P type diffusion layer is formed within an N type semiconductor substrate and an N well which is an N type diffusion layer is formed at top of the P well. Separation regions 10 doped with a P type impurity are provided in parallel to each other with a predetermined space therebetween along an extension direction of the vertical shift register. The N well is electrically divided by adjacent separation regions 10. The region sandwiched by the separation regions 10 forms a channel region 12 which is a transfer route for the information charge. The separation region 10 forms a potential barrier between adjacent channel regions and electrically separates the channel regions 12. An insulating film is formed on a surface of the semiconductor substrate. A plurality of transfer electrodes 14 each made of a polysilicon film are placed on the insulating film in parallel to each other in a direction crossing the extension direction of the channel region 12. In the present embodiment, a vertical transfer method using three-phase vertical clock pulses φᵥ₁-φᵥ₃ is employed, and a group of three transfer electrodes 14-1, 14-2, and 14-3 which are adjacent along the vertical transfer direction corresponds to a light receiving pixel. The present invention, however, is not limited to such a configuration of three-phase transfer and may be applied to a transfer method of different phases such as two phases and four phases. The vertical shift registers of the imaging section 4i may be formed in a similar manner and are placed continuous to the vertical shift registers of the storage section 4s.

In the connection region between the storage section 4s and the horizontal transfer section 4h, an auxiliary transfer electrode 16 having a two-layer structure is formed on the insulating film. Auxiliary transfer electrodes 16-1 are placed in parallel to each other and continuous with the transfer electrodes 14-1-14-3 above the channel region 12. An auxiliary transfer electrode 16-2 is placed in a serpentine manner to be close to the auxiliary transfer electrode 16-1 on odd lines and to be close to an auxiliary transfer electrode 16-4 on even lines. An auxiliary transfer electrode 16-3 is placed in a serpentine manner to be close to the auxiliary transfer electrode 16-4 on the odd lines and to be close to the auxiliary transfer electrode 16-1 on the even lines, which is opposite to the auxiliary transfer electrode 16-2, and is placed to cross the auxiliary transfer electrode 16-2 above the separation region 10. The auxiliary transfer electrode 16-4 is placed on a side nearer to the output than are the auxiliary transfer electrodes 16-2 and 16-3. The auxiliary transfer electrode 16-4 is placed to be close to the auxiliary transfer electrode 16-3 on the odd lines and to be close to the auxiliary transfer electrode 16-2 on the even lines. The auxiliary transfer electrodes 16-1 to 16-4 are formed via insulating film each other. By applying four-phase auxiliary clock pulses φᵤ₁-φᵤ₄ to the auxiliary transfer electrodes 16-1-16-4, respectively, it is possible to temporarily store the information charge for one pixel in the channel region 12 of the even line during transfer of the information charge from the storage section 4s to the horizontal transfer section 4h. The auxiliary transfer electrode 16 is not limited to the structure controlled in four phases and an alternative structure may be employed as long as the structure enables delaying of the information charge of the even line by one pixel with respect to the information charge of the odd line and vertical transfer to the horizontal transfer section 2h.

The horizontal transfer section 4h comprises a horizontal shift register which receives and transfers the information charge output from the vertical shift register of the storage section 4s. The horizontal transfer section 4h in the present embodiment comprises a two-phase driven horizontal shift register. The present invention, however, is not limited to the two-phase driven horizontal shift register and may be applied to horizontal shift registers of different driving methods.

The horizontal shift register comprises a channel region 22 and a horizontal transfer electrode 24. The horizontal shift register is formed in the following manner. A P well (PW) which is a P type diffusion layer is formed in an N type semiconductor substrate and an N well which is an N type diffusion layer is formed at top of the P well. Horizontal separation regions 26 doped with a P type impurity are formed along the extension direction of the horizontal shift register. The N well is electrically divided by the separation region 10 and the horizontal separation region 26 and a region sandwiched by the separation region 10 and the horizontal separation region 26 forms a channel region 22 which is a transfer route for the information charge. The channel region 22 is separated along a direction crossing the extension direction of the vertical shift register by the separation region 10 extending from the vertical shift register of the storage section 4s and the horizontal separation region 26 which is the P type diffusion layer provided opposing the storage section 4s. The channel region 12 of the vertical shift register and the channel region 22 of the horizontal shift register are connected via a gap between extending separation regions 10. The channel region 22 forms a transfer route for the information charge in the horizontal shift register.

In a two-phase driven horizontal shift register, a surface of the semiconductor substrate below even-numbered horizontal transfer electrodes 24-2, 24-4, 24-6, 24-8, 24-10, and 24-12 in the N well of the channel region 22 is doped with a P type impurity. With this structure, even when the horizontal transfer electrodes 24-1-24-12 are set to the same potential, potential barriers are formed, at a predetermined spacing along the extension direction of the channel region 22, in a region of the channel region 22 below the horizontal transfer electrodes 24-2, 24-4, 24-6, 24-8, 24-10, and 24-12.

The horizontal transfer electrode 24 is formed above the channel region 22 extending along a direction perpendicular to the vertical shift register. Two horizontal transfer electrodes 24 for each vertical shift register are formed in order from the vertical shift register of the odd line adjacent to the outputting section 4d of the horizontal shift register. In the present embodiment, 12 horizontal transfer electrodes 24-1-24-12 are formed as a group and are placed in order along the transfer direction of the horizontal shift register. Here, the horizontal transfer electrodes 24-1, 24-3, 24-5, 24-7, 24-9, and 24-11 placed on a line extended from the channel region 12 of the vertical shift register are placed above the channel region 22 with the insulating film therebetween over the channel region 12 and the horizontal separation region 26. The horizontal transfer electrodes 24-2, 24-4, 24-6, 24-8, 24-10, and 24-12 are placed above the channel region 22 in such a manner that a portion of the horizontal transfer electrodes overlaps the adjacent horizontal transfer electrodes 24-1, 24-3, 24-5, 24-7, 24-9, and 24-11 with the insulating film therebetween, over the separation region 10 and the horizontal separation region 26. In the present embodiment, groups of 12 horizontal transfer electrodes 21-1-24-12 corresponding to 6 consecutive vertical shift registers along the horizontal transfer direction are placed in a repeated manner along the horizontal transfer direction. In addition, horizontal clock pulses φₕ₁-φₕ₆ are applied to the horizontal transfer electrodes 24-1-24-12. In this configuration, horizontal clock pulses φₕ₁-φₕ₆ which can be independently controlled from each other are applied for groups of adjacent horizontal transfer electrodes such as the group of horizontal transfer electrodes 24-1 and 24-2, the group of horizontal transfer electrodes 24-3 and 24-4, etc., respectively.

Next, each constituent element of the driving device 6 will be described. The frame clock pulse generating section 6f generates three-phase frame clock pulses φ_{f} in correspondence to a frame shift timing signal FT supplied from the outside and supplies the frame clock pulse to the transfer electrode of the vertical shift register of the imaging section 4i. When the frame clock pulse φ_{f} is supplied, the information charge stored in each light receiving pixel of the imaging section 4i is transferred to the storage section 4s at each vertical scan period. The vertical clock pulse generating section 6v generates three-phase vertical clock pulses v in correspondence to a vertical synchronization signal VT and a horizontal synchronization signal HT and supplies the generated vertical clock pulse to the transfer electrode of the vertical shift register of the storage section 4s. In the present embodiment, in the imaging section 4i and the storage section 4s, three transfer electrodes 14-1-14-3 which are consecutively placed correspond to one horizontal line. Therefore, the information charge can be vertically transferred for each horizontal line by applying, as the frame clock pulse φ_{f} and the vertical clock pulse φᵥ, three-phase clock pulses which change in phases differently from each other onto the transfer electrodes 14-1-14-3. The horizontal clock pulse generating section 6h generates horizontal clock pulses φₕ in correspondence to the horizontal synchronization signal HT and supplies the generated horizontal clock pulse to the horizontal transfer electrode 24 of the horizontal transfer section 4h. It is assumed that the horizontal clock pulse generating section 6h can generate horizontal clock pulses φₕ which can be controlled independently from each other for the horizontal transfer electrodes 24 coupled to n consecutive vertical shift registers, when the information charges of n bits (pixels) are to be added, combined, and transferred in the horizontal shift register. In particular, when bits (pixels) for storing information charges corresponding to m different colors (where m is a natural number of 2 or greater) are placed one by one in a repeated configuration along the transfer direction, and when information charges stored in n bits (where n is a natural number of two or greater) are to be added, combined, and transferred, it is preferable to group transfer electrodes corresponding to the m×n bits which are consecutively placed and enable control of the clock pulses to be applied to the transfer electrode of each group independently from each other. In the present embodiment, bits (pixels) for storing information charges corresponding to two different colors are alternately placed along the transfer direction and information charges for three bits (pixels) are added and combined. Thus, 6-phase horizontal clock pulses Ph can be generated which can be controlled independently from each other for 12 horizontal transfer electrodes 24-1-24-12 coupled to 6 vertical shift registers. The auxiliary clock pulse generating section 6u generates, in correspondence to the horizontal synchronization signal HT, 4-phase auxiliary clock pulses φᵤ having a frequency which is ½ of the transfer period for one bit of the vertical clock pulse φᵥ and supplies the generated pulse to the auxiliary transfer electrode 16. With the auxiliary clock pulse φᵤ, the information charge transferred through the vertical shift register of the storage section 4s is transferred to the horizontal transfer section 4h alternately between odd and even lines. The control by the vertical clock pulse φᵥ, horizontal clock pulse φₕ, and auxiliary clock pulse φᵤ will be described later in detail.

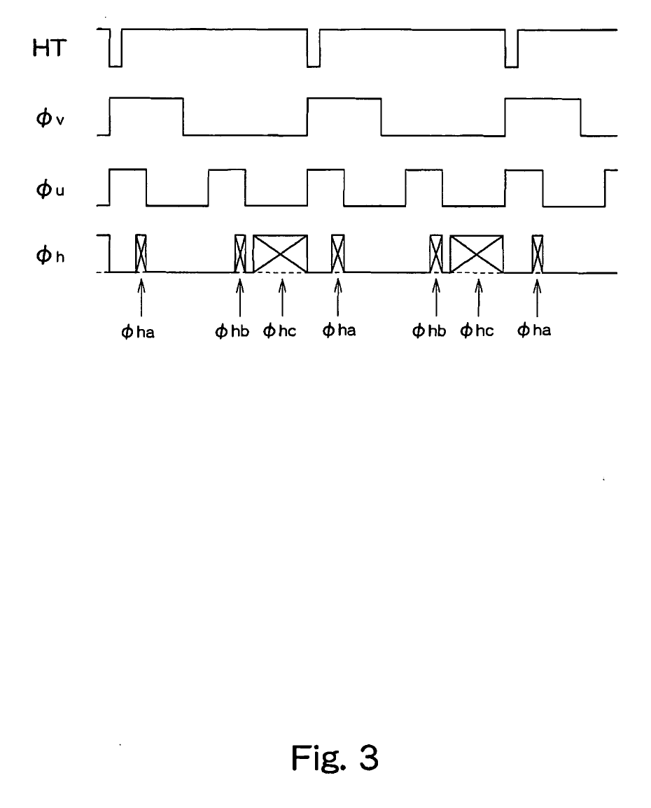

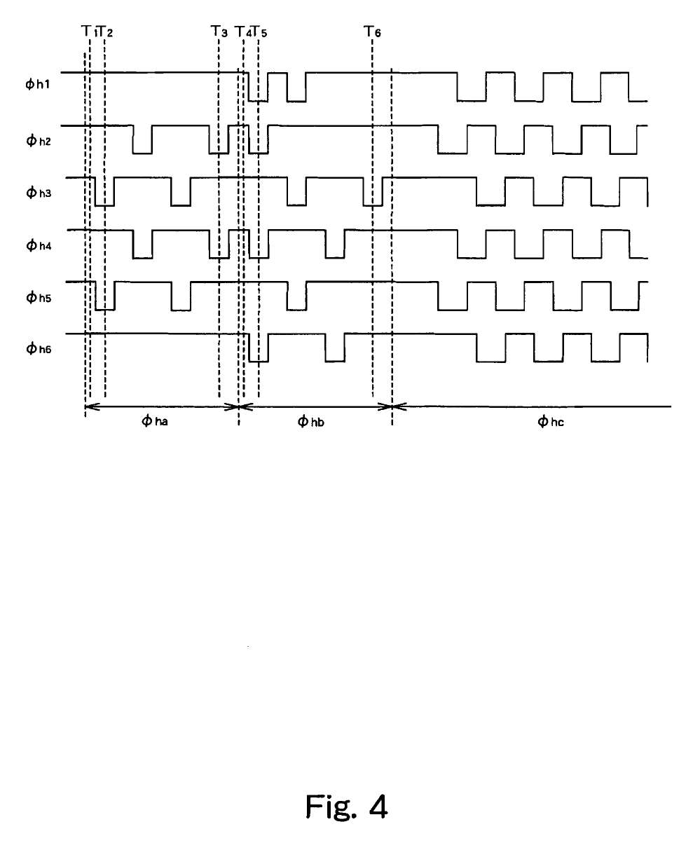

FIGS. 3 and 4 show a timing chart of clock pulses when the solid state imaging device according to the present embodiment is used to reduce resolution of an image and achieve high-speed transfer. FIG. 3 shows a relationship between the horizontal synchronization signal HT, vertical clock pulse φᵥ, auxiliary clock pulse φᵤ, and horizontal clock pulse φₕ. FIG. 4 shows a change of the horizontal clock pulse Ph during horizontal transfer. The vertical clock pulses φᵥ are of 3 phases and the auxiliary clock pulses φᵤ are of 4 phases, but only the representative clock is shown in FIG. 3.

The vertical clock pulses φᵥ are applied to the transfer electrodes 14-1-14-3 at a period corresponding to the horizontal synchronization signal HT. The vertical clock pulses φᵥ include three-phase pulses φᵥ₁-φᵥ₃ which change at phases different from each other. With this structure, the information charge is transferred line by line at each horizontal transfer period along the channel region 12 of the vertical shift register. The auxiliary clock pulses φᵤ are applied to the auxiliary transfer electrodes 16-1-16-4 in correspondence to a period which is ½ of the period of the horizontal synchronization signal HT. As described above, the auxiliary transfer electrodes 16-1-16-4 effectively operate only at the output end of the vertical shift register of the even line, and thus the potential state is controlled at the channel region 12 of the vertical shift register of the even line so that the transfer takes place for two pixels in one horizontal transfer period. In this process, because the information charge of only one pixel is transferred, with the vertical clock pulse φᵥ, during one horizontal transfer period from the transfer electrodes 14-1-14-3 to the auxiliary transfer electrodes 16-1-16-4, the information charge of one pixel is transferred to the horizontal shift register at a timing differing by a period which is approximately ½ of the horizontal transfer period, between the vertical shift register of the odd line and the vertical shift register of the even line.

The horizontal clock pulse φₕ is generated in correspondence to the vertical clock pulse φᵥ and the auxiliary clock pulse φᵤ and is applied to the horizontal transfer electrodes 24-1-24-12 at a period which is shorter than the horizontal transfer period. In the present embodiment, the horizontal clock pulses φₕ include a combination of charge combining clock pulses φₕₐ and φ_{hb} and a charge transfer clock pulse φ_{hc}. With this structure, information charges of a plurality of bits (pixels) corresponding to the same wavelength band (same color) contained in one horizontal line are added and combined in the horizontal shift register and are output to the outputting section 4d.

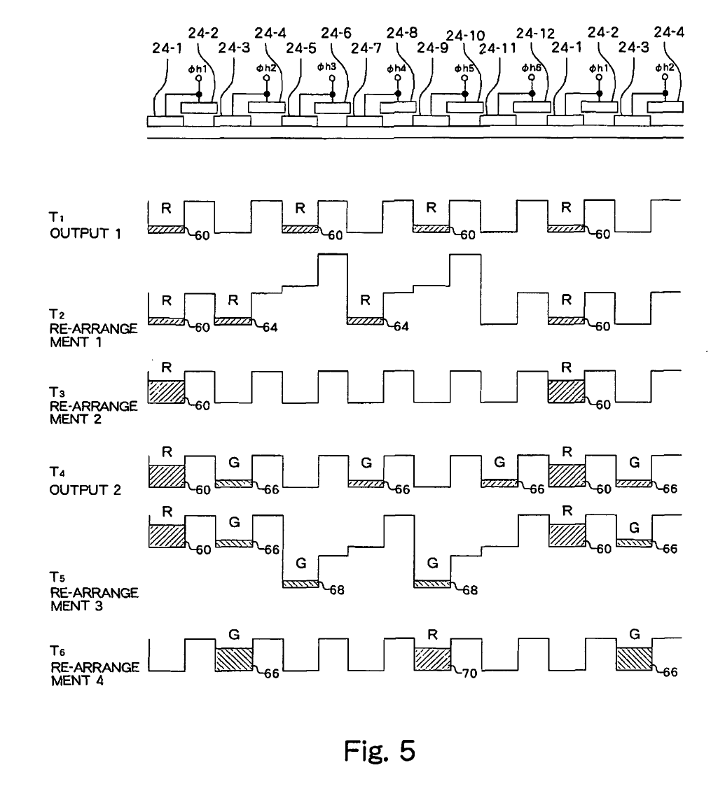

FIG. 5 shows a state of a potential well formed in the horizontal shift register when the horizontal clock pulse φₕ is applied. In FIG. 5, the horizontal axis represents positions corresponding to the horizontal transfer electrodes 24-1-24-12 and the vertical axis represents a potential, with the upward direction being a negative potential and the downward direction being a positive potential.

In the present embodiment, the horizontal clock pulses φₕ₁-φₕ₆ applied to the horizontal transfer electrodes 24-1-24-12 are independently controlled so that information charges of only three bits (pixels) corresponding to the same color are added and combined. Here, it is assumed that information charges corresponding to red (R) and green (G) are transferred to the final stages of the vertical shift registers of the odd and even lines of the storage section 2s, respectively.

At a time T₁, the horizontal clock pulses φₕ₁-φₕ₆ to be applied to the horizontal transfer electrodes 24-1-24-12 are set to the high level, and the information charge of red (R) transferred from the odd line of the vertical shift register is stored in the potential wells 60 formed below the horizontal transfer electrodes 24-1, 24-5, and 24-9.

At a time T₂, the horizontal clock pulses φₕ₃ and φₕ₅ applied to the horizontal transfer electrodes 24-5, 24-6, 24-9, and 24-10 are changed to the low level, and the information charges of red (R) stored in the potential wells 60 below the horizontal transfer electrodes 24-5 and 24-9 are transferred to the potential wells 64 below the horizontal transfer electrodes 24-3 and 24-7. Then, the transfer process is repeated, and at a time T₃ the information charges of red (R) stored in the potential wells 60 below the horizontal transfer electrodes 24-5 and 24-9 at the time T₁ are added to and combined with the information charge of red (R) stored in the potential well 60 below the horizontal transfer electrode 24-1. At this time, the horizontal clock pulses φₕ₁-φₕ₆ to be applied to the horizontal transfer electrodes 24-1-24-12 are returned to the high level.

At a time T₄, the horizontal clock pulses φₕ₁-φₕ₆ to be applied to the horizontal transfer electrodes 24-1-24-12 are maintained at the high level and the information charge of green (G) transferred from the even line of the vertical shift register is stored in potential wells 66 formed below the horizontal transfer electrodes 24-3, 24-7, and 24-11. At this time, the information charge of red (R) which is already added and combined is stored in the potential well 60 below the horizontal transfer electrode 24-1.

At a time T₅, the horizontal clock pulses φₕ₁, φₕ₂, φₕ₄, and φₕ₆ applied to the horizontal transfer electrodes 24-1, 24-2, 24-7, 24-8, 24-11, and 24-12 are changed to the low level and the information charges of green (G) stored in the potential wells 66 below the horizontal transfer electrodes 24-7 and 24-11 are transferred to the potential wells 68 below the horizontal transfer electrodes 24-5 and 24-9, respectively.

At this time, at least one of the horizontal clock pulses φₕ₅ and φₕ₁ applied to the horizontal transfer electrodes 24-9, 24-10, 24-1, and 24-2 corresponding to the bits (pixels) positioned at a stage later than the horizontal transfer electrodes 24-7, 24-8, 24-11, and 24-12 corresponding to the bits (pixels) from which the information charges are to be transferred is simultaneously changed to the low level. In this description, the horizontal clock pulse φₕ₁ applied to the horizontal transfer electrodes 24-1 and 24-2 corresponding to the bits of the first stages of a next group adjacent to the horizontal transfer electrodes 24-10 and 24-11 corresponding to the bits of the final stages of the horizontal transfer electrodes 24-1-24-12 forming the group is changed to the low level. With this process, it is possible to prevent the situation in which the depth of the potential well 60 storing the information charge of red (R) which has already been added and combined is reduced due to the change of the potential well 68 storing the information charge of green (G) to be transferred. Therefore, it is possible to prevent leakage of the information charge of red (R) stored in the potential well 60 into the adjacent potential well 66.

Then, the transfer process is repeated, and at a time T₆ the information charge of green (G) stored in the potential wells 66 below the horizontal transfer electrodes 24-7 and 24-11 at the time T₄ are added and combined with the information charge of green (G) stored in the potential well 66 below the horizontal transfer electrode 24-3. At this point, the information charge of red (R) stored in the potential well 60 below the horizontal transfer electrode 24-1 is also sequentially transferred to a potential well 70 below the horizontal transfer electrode 24-9. The information charge stored in the potential well 60 formed below the horizontal transfer electrode 24-1 at the output end of the horizontal shift register is transferred to the outputting section 4d.

After the information charges of one horizontal line are added and combined for a group of three bits (pixels) in this manner, the information charge is horizontally transferred by applying three-phase horizontal clock pulses φₕ having different phases to a group of electrodes of three bits from among the horizontal transfer electrodes 24-1-24-12. In other words, as shown in the period of the horizontal clock pulse φ_{hc} of FIG. 4, in the present embodiment, the horizontal transfer electrodes 24-1-24-6 and the horizontal transfer electrodes 24-7-24-12 are separately grouped and three-phase horizontal clock pulses φₕ₁-φₕ₁₂ are applied to each group so that information charges which are added and combined are horizontally transferred. With this process, the information charges stored in the potential wells 66 and 70 are sequentially transferred along the horizontal transfer direction to the outputting section 4d.

When horizontal transfer of one horizontal line is completed, the process proceeds to the vertical transfer with respect to the next horizontal line, as shown in FIG. 3. When color filters are placed in a manner shown in FIG. 7, information charges corresponding to the wavelength bands of green (G) and blue (B) are alternately transferred in place of the information charges corresponding to the wavelength bands of red (R) and green (G).

As described, in the present embodiment, information charges of a plurality of bits (pixels) corresponding to the wavelength band of the same color are added and combined along the horizontal transfer direction and then horizontally transferred. With this structure, it is possible to substantially reduce the number of transfer stages and shorten the transfer time of information charges during horizontal transfer, compared to the conventional structures, without increasing the base frequency of the clock pulses. Therefore, it is possible to rapidly obtain an image when an image of low resolution is to be obtained.

By simultaneously changing, during transfer of information charge, at least one of the horizontal clock pulses applied to the horizontal transfer electrodes corresponding to the bits (pixels) positioned at a later stage than the horizontal transfer electrode corresponding to the bit (pixel) from which the information charge is to be transferred, to a potential which is lower than that of the ON state, it is possible to prevent reduction in the depth of the potential well of the adjacent bit (pixel) due to the change of the potential well of the bit (pixel) storing the information charge to be transferred. With this structure, it is possible to prevent leakage of the information charges to the adjacent potential well and degradation of the reproducibility of an image signal to be output (color reproducibility).

In the present embodiment, the horizontal clock pulses applied to the horizontal transfer electrodes corresponding to two bits positioned at the later stage are simultaneously changed to a potential lower than that of the ON state. In this process, φₕ₁ and φₕ₈ are simultaneously set to a potential lower than that of the ON state in order to prevent reduction of the depth of the potential well 60 because of the presence of the coupling capacitance between the electrodes 24-12 and 24-1 and due to the change in the potential of φₕ₈. Similarly, φₕ₂ is set to a potential lower than that of the ON state simultaneously with φₕ₈ and φₕ₁ in order to prevent insufficient height of the potential barrier of the electrode 24-2 during the change of φₕ₁ because of the presence of the coupling capacitance between the electrodes 24-2 and 24-3. The advantage of the present invention can be obtained by changing only φₕ₁ simultaneously with φₕ₈.

The adding and combining processes of the information charges in the horizontal shift register are not limited to this configuration and an alternative method may be employed as long as the method enables addition and combination of information charges while preventing mixture of information charges corresponding to wavelength bands of different colors contained in a horizontal line. For example, when the information charges contained in a horizontal line correspond to different colors in odd and even lines of the vertical shift register as in the present embodiment, a method can be employed which enables separate addition and combination of the information charges of odd lines and information charges of even lines.

When it is desired to not add and combine the information charges and output as a high-resolution image signal, it is possible to control the horizontal shift register with a four-phase horizontal clock pulses φₕ in a manner similar to the related art so that the information charge is horizontally transferred in units of one bit (pixel).

It is also possible to enable the horizontal clock pulses φₕ to be independently controlled for 16 phases and control 16 horizontal transfer electrodes 24 coupled to 8 consecutive vertical shift registers with the horizontal clock pulses φₕ, to enable adding and combining of information charges of four bits (pixels) and horizontal transfer of the information charge. In order to increase the number of phases of the horizontal clock pulses φₕ to be independently controlled, however, the complexity and size of the circuit structure of the horizontal clock pulse generating section 6h may be increased, and the number of pins provided on the chip of the CCD solid state imaging element 4 may also be increased. Therefore, the number of phases of the horizontal clock pulses φₕ may be determined in consideration of these factors.

Although the preferred embodiment has been described with reference to an example case of a two-phase driven shift register, the present invention is not limited to such a configuration and may be applied, for example, to three-phase and four-phase driven shift registers. In such a case, a horizontal clock pulse having a potential which is lower than that of the ON state can be applied, during transfer of information charge, to the horizontal transfer electrode corresponding to the bit (pixel) positioned at a later stage than the horizontal transfer electrode corresponding to the bit (pixel) from which the information charge is to be transferred, in order to prevent a change of depth of the potential well.

In either case, by simultaneously changing, during transfer of the information charge, at least one of the horizontal clock pulses applied to the horizontal transfer electrode corresponding to a bit (pixel) of a later stage than the horizontal transfer electrode corresponding to the bit (pixel) from which the information charge is to be transferred, to a potential lower than that of the ON state, it is possible to prevent reduction in the depth of the potential well of the adjacent bit (pixel) due to a change of the potential well of the bit (pixel) storing the information charge to be transferred.

What is claimed is:

1. A driving device of a solid state imaging element, wherein
when a transfer electrode corresponding to a bit of an earlier stage along a transfer direction between two adjacent bits is set to an ON state and a transfer electrode corresponding to a bit of a later stage along the transfer direction between the two bits is set to an OFF state having a lower potential for electron than the ON state, to transfer an information charge stored in the bit of the later stage along the transfer direction to the bit of the earlier stage along the transfer direction, a transfer electrode corresponding to a bit storing an information charge to be transferred is set to the OFF state and one transfer electrode corresponding to at least one bit at the later stage along the transfer direction which is adjacent to the bit is set to a potential lower than that of the ON state.

2. The driving device according to claim 1, wherein
potential wells of the bit storing the information charge to be transferred and of at least one adjacent bit on the later stage along the transfer direction storing an information charge are maintained at depths which are approximately identical to the depths when the at least one adjacent bit on the later stage along the transfer direction storing the information charge is set to the OFF state.

3. The driving device according to claim 1, wherein
a transfer electrode corresponding to the bit storing the information charge to be transferred is set to the OFF state and a transfer electrode corresponding to a bit, between the bits of later stages along the transfer direction, adjacent to the bit and storing an information charge, is set to a potential which is lower than that of the ON state.

4. The driving device according to claim 2, wherein
a transfer electrode corresponding to the bit storing the information charge to be transferred is set to the OFF state and a transfer electrode corresponding to a bit, between the bits of later stages along the transfer direction, adjacent to the bit and storing an information charge, is set to a potential which is lower than that of the ON state.

5. The driving device according to claim 1, wherein
information charges stored in a plurality of bits are added, combined, and transferred.

6. A driving method for a solid state imaging element, wherein
when a transfer electrode corresponding to a bit of an earlier stage along a transfer direction between two adjacent bits is set to an ON state and a transfer electrode corresponding to a bit of a later stage along the transfer direction between the two bits is set to an OFF state having a lower potential than the ON state, to transfer an information charge stored in the bit of the later stage along the transfer direction to the bit of the earlier stage along the transfer direction, a transfer electrode corresponding to a bit storing an information charge to be transferred is set to the OFF state and one transfer electrode corresponding to at least one bit at the later stage along the transfer direction which is adjacent to the bit is set to a potential lower than that of the ON state.

7. The driving method according to claim 6, wherein
potential wells of the bit storing the information charge to be transferred and of at least one adjacent bit on the later stage along the transfer direction storing an information charge are maintained at depths which are approximately identical to the depths when the at least one adjacent bit on the later stage along the transfer direction storing the information charge is set to the OFF state.

8. The driving method according to claim 6, wherein
a transfer electrode corresponding to the bit storing the information charge to be transferred is set to the OFF state and a transfer electrode corresponding to a bit, between the bits of later stages along the transfer direction, adjacent to the bit and storing an information charge, is set to a potential which is lower than that of the ON state.

9. The driving method according to claim 7, wherein
a transfer electrode corresponding to the bit storing the information charge to be transferred is set to the OFF state and a transfer electrode corresponding to a bit, between the bits of later stages along the transfer direction, adjacent to the bit and storing an information charge, is set to a potential which is lower than that of the ON state.

10. The driving method according to claim 6, wherein
information charges stored in a plurality of bits are added, combined, and transferred.
